(19) United States
(12) Patent Application Publication
(10) Pub. No.: US 2015/0285428 A1
(43) Pub. Date: Oct. 8, 2015

(54) RETAINING APPARATUS

(71) Applicant: Harold Duperron, Spruce Grove (CA)

(72) Inventor: Harold Duperron, Spruce Grove (CA)

(21) Appl. No.: 14/247,569

(22) Filed: Apr. 8, 2014

(51) Int. Cl. F16M 11/04; A45F 3/44; A45F 3/00; F16M 11/02; F16M 13/00

(52) U.S. Cl. CPC F16M 11/041; F16M 11/02; F16M 13/00; A45F 3/00; A45F 3/44; A45F 2003/001

(57) ABSTRACT

A retaining apparatus is disclosed herein. The retaining apparatus includes at least one magnetized bar. The retaining apparatus also includes a tripod having a plurality of legs. The tripod is engaged with the at least one magnetized bar. The at least one magnetized bar is disposed above the plurality of legs.

### BACKGROUND OF THE INVENTION

1. Field of the Invention

The invention relates to an apparatus for retaining items and more particularly to structures that can retain camping cookware.

2. Description of Related Prior Art

U.S. Pat. No. 5,979,673 discloses a MAGNETIC COOKING UTENSIL HOLDER. The magnetic cooking utensil holder allows a user to temporarily secure hot pan lids while cooking eliminating the undesirable practice of placing the hot and sometimes soiled lids on a counter top. The device includes a horizontal tubular magnet having a plurality of support legs pivotally attached thereto which expand to form a tripod type support structure. A drip tray for collecting condensate or food residue adhering to the lid is removably attached to a pair of opposing support legs. A pair of opposing side arms each extending from an end of the magnet have a plurality of vertically aligned magnetic strips thereon for receiving additional cooking utensils such as knives, forks and spoons. Accordingly, whenever a user removes a lid to add ingredients or to stir the food within a pot or pan, the edge of the pan is placed within a drip tray with an opposing portion magnetically secured to the magnetic bar. The tripod type support structure allows the lid to be obliquely suspended with respect to the counter top so that any condensation or food residue adhering to the lid will easily drain into the drip tray.

### SUMMARY OF THE INVENTION

In summary, the invention is a retaining apparatus. The retaining apparatus includes at least one magnetized bar. The retaining apparatus also includes a tripod having a plurality of legs. The tripod is engaged with the at least one magnetized bar. The at least one magnetized bar is disposed above the plurality of legs.

### BRIEF DESCRIPTION OF THE DRAWINGS

The detailed description set forth below references the following drawings:

FIG. 1 is a perspective view of an exemplary embodiment of the invention; and

FIG. 2 is an exploded view of kit according to an exemplary embodiment of the invention.

### DETAILED DESCRIPTION OF AN EXEMPLARY EMBODIMENT

The invention, as demonstrated by the exemplary embodiment described below, can provide a device to retain cookware used during camping. One or more embodiments of the invention can prevent camping cookware from being supported against a cooler which might burn or melt. One or more embodiments of the invention can prevent camping cookware from being against a table, which would be unstable. Further, one or more embodiments of the invention can allow camping cookware to be supported off of the ground, where the cookware can safely and sanitarily cool.

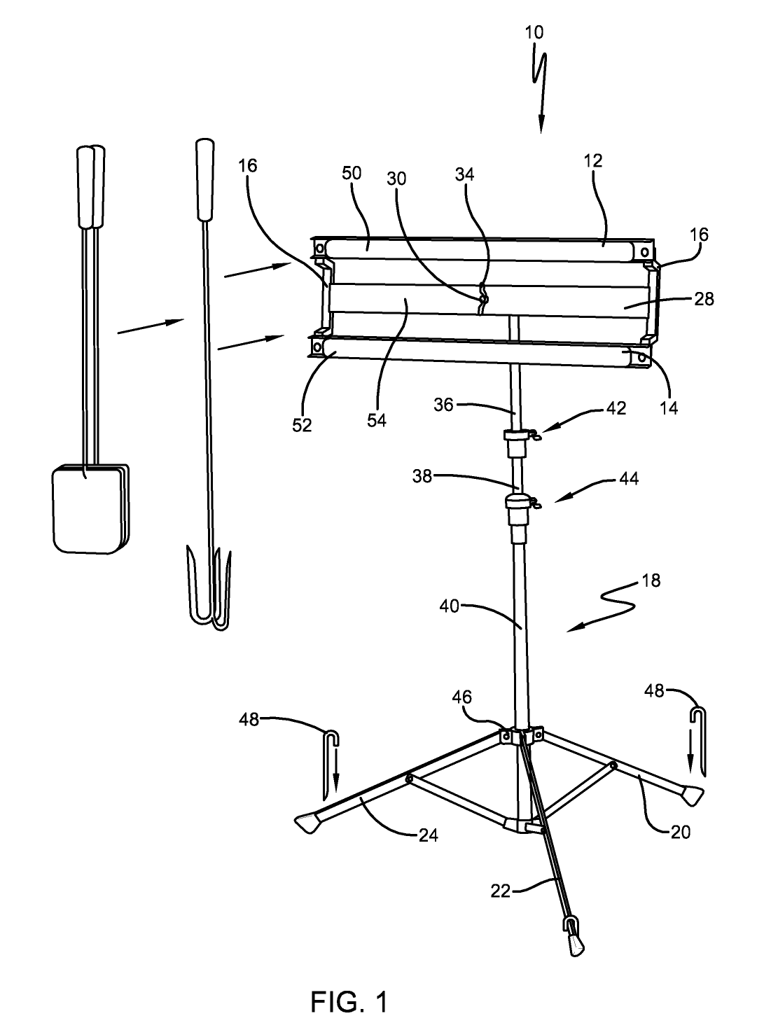

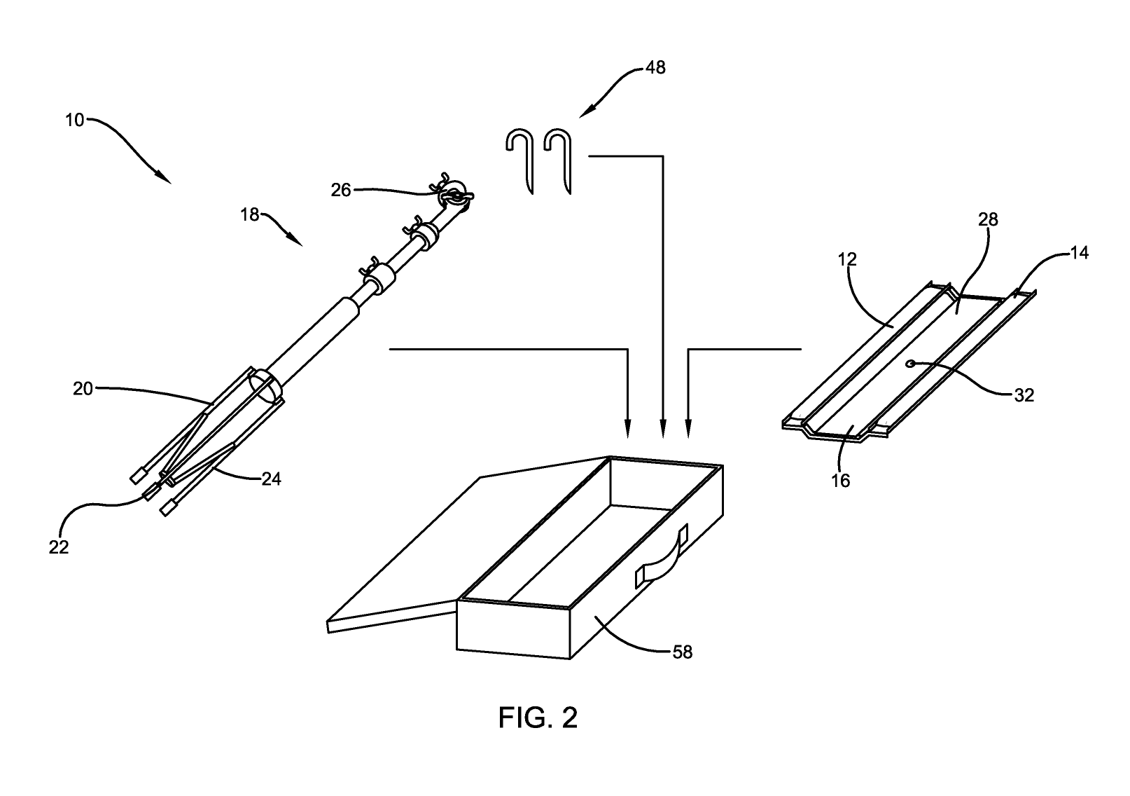

Referring now to FIGS. 1 and 2, a retaining apparatus 10 for retaining camping cookware includes at least one magnetized bar. The exemplary embodiment includes first and second magnetized bars 12, 14. The bars 12, 14 can be mounted on a frame 16. The bars 12, 14 can be spaced from one another on the frame 16. The frame 16 can be shaped such that an open gap is defined between the first and second magnetized bars 12, 14.

The retaining apparatus 10 also includes a tripod 18 having a plurality of legs 20, 22, 24. The tripod 18 is engaged with the at least one magnetized bar, which is disposed above the plurality of legs 20, 22, 24. In the exemplary embodiment, the first and second magnetized bars 12, 14 are disposed above the plurality of legs 20, 22, 24.

The frame 16 can be operably disposed between the at least one magnetized bar and the tripod 18. In other words, the frame 16 can interconnect the first and second magnetized bars 12, 14 with the tripod 18. The frame 16 and the tripod 18 can be releasibly engageable with one another. Thus, the first and second magnetized bars 12, 14 can be releasibly engageable with the tripod 18.

A third bar 28 can be mounted on the frame 16. The third bar 28 can be recessed from and between the first and second magnetized bars 12, 14. When mounting an article of camping cookware on the apparatus 10, a user's hand can be generally aligned with third bar 28. The third bar 28 can be useful for attaching the frame 16 to the tripod 18 so that the plane of the magnetic bars 12, 14 is not broken by mounting hardware. A bolt 30 can pass through an aperture 32 in the third bar 28. The bolt 30 can be pivotally mounted on the tripod 18 to allow the bars 12, 14 to hold a number of different positions. The bolt 30 can receive a nut 34 for releasibly affixing the frame 16 to the tripod 18.

In one or more embodiments of the broader invention, the tripod 18 can be collapsible. FIG. 1 shows that the exemplary tripod 18 includes three shaft portions 36, 38, 40 telescopically engaged with one another. The tripod 18 also includes two locks 42, 44 to selectively lock the shaft portions 36, 38, 40 together. This arrangement allows the height of the tripod 18, and the bars 12, 14, to be adjustable. The legs 20, 22, 24 can be pivotally engaged with a ring 46 that can slide along the shaft portion 40 to collapse the legs 20, 22, 24. The collapsed tripod 18 is shown in FIG. 2.

The magnetic head formed from the frame 16 and the bars 12, 14 can swivel and tilt as it is on a gear clamp with a wing nut that can be loosened. The head can be tilted down or faced straight up. It can also be positioned to be totally vertical instead of horizontal if so needed.

The apparatus 10 can also include a plurality of stakes, referenced generally at 48. Each stake 48 can be engageable with one of the plurality of legs 20, 22, 24. A hook portion of each stake 48 can extend around one of the legs 20, 22, 24, while a straight portion of each stake 48 can be driven into the ground. The stakes 48 can thus stabilize the tripod 18 to the ground.

In one or more embodiments of the broader invention, the apparatus 10 can also include reflective strips. This feature allows the apparatus 10 to be more visible in later hours and thus enhances safety. The exemplary embodiment includes strips 50, 52, 54 disposed on bars 12, 14, 28. In various embodiments, the reflective strips can be a coating on the bars 12, 14, 28 or structure formed independently of the bars 12, 14, 28 and then attached to the bars 12, 14, 28. Embodiments of the broader invention can include reflective material such as the reflective material used in traffic safety equipment. Scotchlite™ from 3M™ is one kind of reflective material that can be used.

FIG. 2 shows a kit 56 that can be gathered with the exemplary embodiment. The stakes 48 have been removed from the tripod 18 and the ground, freeing the tripod 18. The frame 16 has been disconnected from the tripod 18. The tripod 18 has been collapsed and reduced in size. A container 58 can be operable to concurrently hold the frame 16 with the bars 12, 14, the tripod 18, and the plurality of stakes 48. The container 58 can be bag-like (formed from cloth) or can be box-like (formed from rigid materials).

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Further, the “invention” as that term is used in this document is what is claimed in the claims of this document. The right to claim elements and/or sub-combinations that are disclosed herein as other inventions in other patent documents is hereby unconditionally reserved.

1. A retaining apparatus comprising:
at least one magnetized bar;
a frame; and
a tripod having a plurality of legs and engaged with said at least one magnetized bar, wherein said at least one magnetized bar is disposed above said plurality of legs, said frame operably disposed between said at least one magnetized bar and said tripod to elevate and space said at least one magnetized bar from said plurality of legs.

2. (canceled)

3. The retaining apparatus of claim 1 wherein said at least one magnetized bar is further defined as:
first and second magnetized bars, each mounted on said frame and spaced from one another.

4. The retaining apparatus of claim 3 further comprising:
first and second reflective strips individually disposed on one of said first and second magnetized bars.

5. The retaining apparatus of claim 3 further comprising:
a third bar mounted on said frame recessed from and between said first and second magnetized bars.

6. The retaining apparatus of claim 1 wherein said at least one magnetized bar is further defined as:
first and second magnetized bars, each engaged with said tripod and spaced from one another.

7. The retaining apparatus of claim 1 further comprising:
a reflective strip disposed on said at least one magnetized bar.

8. The retaining apparatus of claim 1 wherein said tripod is further defined as collapsible.

9. The retaining apparatus of claim 1 wherein said at least one magnetized bar and said tripod are further defined as releasibly engageable with one another.

10. The retaining apparatus of claim 1 further comprising:
a plurality of stakes, each stake engageable with one of said plurality of legs.

11. A kit comprising:
at least one magnetized bar;
a frame;
a tripod positioned at one end of said frame and having a plurality of legs and engaged with said at least one magnetized bar through said frame, wherein said at least one magnetized bar is disposed above, elevated and spaced from said plurality of legs;
a plurality of stakes, each stake engageable with one of said plurality of legs; and
a container operable to concurrently hold said at least one magnetized bar, said tripod and said plurality of stakes.

12. A retaining apparatus for camping cookware comprising:
a frame;
first and second magnetized bars, each mounted on said frame and spaced from one another, said frame shaped such that an open gap is defined between said first and second magnetized bars;
a tripod positioned at a bottom of said frame and having a plurality of legs and engaged with said first and second magnetized bars through said frame, wherein said first and second magnetized bars are disposed above, elevated and spaced from said plurality of legs; and
a plurality of stakes, each stake engageable with one of said plurality of legs to stabilize said tripod to the ground.
